(19) United States
(12) Patent Application Publication
(10) Pub. No.: US 2022/0358610 A1
(43) Pub. Date: Nov. 10, 2022

(54) METHOD OF INSTRUCTING PROCEEDS WITH ONE OR MORE NAMED BENEFICIARIES

(71) Applicant: Thomas Schreiner, Westfield, NJ (US)

(72) Inventor: Thomas Schreiner, Westfield, NJ (US)

(21) Appl. No.: 17/870,853

(22) Filed: Jul. 22, 2022

Related U.S. Application Data
(63) Continuation-in-part of application No. 16/420,252, filed on May 23, 2019.
(60) Provisional application No. 62/676,186, filed on May 24, 2018.

(51) Int. Cl. G06Q 50/18

(52) U.S. Cl. CPC G06Q 50/186

(57) ABSTRACT

Systems and methods are provided for providing one or more recipients with instructions on how to distribute proceeds with one or more named beneficiaries. The method includes opening, on an electronic device, a digital application configured to enable a user to input information pertaining to how to distribute the proceeds, inputting, using a graphical user interface coupled to the electronic device, the information pertaining to how to distribute the proceeds, generating a form using the information pertaining to how to distribute the proceeds, inputting, using the graphical user interface, one or more recipients of the form, sending the form to the one or more recipients, and sending an alert to the user to update information pertaining to how to distribute the proceeds at a conclusion of a time interval.

### CROSS-REFERENCE TO RELATED APPLICATIONS SECTION

This application is a U.S. Non-Provisional patent application and Continuation-in-Part (CIP) patent application that claims priority to U.S. Non-Provisional patent application Ser. No. 16/420,252 filed on May 23, 2019, which claims priority to U.S. Provisional Patent Application Ser. 62/676,186 filed on May 24, 2018, the entire contents of which are hereby incorporated by reference in their entirety.

### FIELD OF THE EMBODIMENTS

This invention relates to distributing funds to named beneficiaries and, in particular, to methods of instructing how named beneficiaries are to use proceeds.

### BACKGROUND OF THE EMBODIMENTS

After a person passes away, the desires of the deceased, in regards to their belongings, insurance benefits, retirement accounts, savings accounts, etc., often changes over time and is often unknown to those that survive the deceased. This may lead to confusion, arguments, and discontent between those who have survived the deceased as to what should be done with the items, money, etc.

Even if instructions are left, the instructions may be old, and the deceased's true intentions at the time of his/her death may be in question. Questions as to the true intent may also lead to further discontent between those that survive the deceased.

For at least these reasons, a system and method for preparing and periodically updating a means for instructing how named beneficiaries are to use proceeds (e.g., life insurance proceeds, annuities, IRA accounts, etc.) is needed.

### EXAMPLES OF RELATED ART ARE DESCRIBED BELOW

U.S. Pat. No. 7,860,735 generally describes an online life insurance document management service that includes a host server having a web-based interface adapted to facilitate secure customer access to the host server. The host server is configured to receive life insurance data communicated from the customer through use of a computing device. A processing module is in operative communication with the host server and is configured to process the life insurance data communicated from the customer. A processing software application is trained to classify the processed life insurance data and selectively extract data therefrom based on the classification. The processing software application is configured to selectively present the processed life insurance data for a customer verification via the web-based interface upon at least one of an unsuccessful classification and an unsuccessful extraction of data. A storage device is in operative communication with the processing module and is configured to store the extracted data as metadata upon at least one of the customer verification and the extraction of data. A content management software application is configured to detect at least one of a customer request and at least one triggering condition. The content management software application generates at least one report based on the detection of at least one of the customer request and the at least one triggering condition.

U.S. Pat. No. 8,688,556 generally describes a method that includes generating a first interactive graphical user interface (GUI) that identifies one or more guaranteed income options to fund essential retirement expenses and receiving a selection of a guaranteed income option. The method includes generating a second interactive GUI that identifies one or more investment options to fund lifestyle retirement expenses and receiving a selection of an investment option. The method includes generating a third interactive GUI that identifies one or more unexpected liability coverage options and receiving a selection of an unexpected liability coverage option. The method includes generating a fourth interactive GUI that identifies one or more legacy planning options and receiving a selection of a legacy planning option. The method includes generating a retirement plan that identifies the selected guaranteed income option, the selected investment option, the selected unexpected liability coverage option, and the selected legacy planning option.

U.S. Pat. No. 9,613,376 generally describes an apparatus and method of maintaining beneficiary information are disclosed. The apparatus can be configured to perform the method, which may include obtaining information for one or more recipients of one or more conveyances of property, obtaining one or more digital IDs from the one or more recipients, maintaining the one or more digital IDs from the one or more recipients by periodically sending notifications to the one or more recipients, and distributing assets with the one or more digital IDs to the one or more recipients.

U.S. Patent Publication No. 2016/0125543 generally describes systems including a life insurance platform and a user-directed platform. The life insurance platform maintains a life insurance policy associated with a cash value back by investment assets. A user-directed investment account platform maintained a user-directed investment account funded by a margin account based on the cash value of the life insurance policy. The system can determine a change in the value of the investment assets and can, in turn, modify the value of the margin account based on the change. The user-directed investment account platform can identify the modified value of the margin account and update the user-directed investment account based on the same. That platform can also provide an interface for providing information related to the user-directed investment account while also providing information related to the life insurance policy.

U.S. Patent Publication No. 2016/0125547 generally describes systems including a life insurance platform and a user-directed investment platform. The life insurance platform maintains a life insurance policy associated with a cash value backed by investment assets. A user-directed investment account platform maintains a user-directed investment account funded by a margin account based on the cash value of the life insurance policy. The system can determine a change in the value of the investment assets and can, in turn, modify the value of the margin account based on the change. The user-directed investment account platform can identify the modified value of the margin account and update the user-directed investment account based on the same. That platform can also provide an interface for providing information related to the user-directed investment account while also providing information related to the life insurance policy.

U.S. Patent Publication No. 2017/0270483 generally describes a personnel management system.

None of the art described above addresses all of the issues that the present invention does.

### SUMMARY OF THE EMBODIMENTS

This invention relates to distributing funds to named beneficiaries and, in particular, to methods of instructing how named beneficiaries are to use proceeds.

A first embodiment of this invention describes a method executed by a computing device for providing one or more recipients with instructions on how to distribute proceeds (e.g., life insurance proceeds) with one or more named beneficiaries. The method includes numerous process steps, such as: receiving, from a user and via a digital application executable on the computing device, identifiable information associated with the user. The identifiable information includes at least a name of the user, an address of the user, an email address of the user, an insurance provider associated with an insurance policy for the user, the insurance policy number for the user, an insurance policy amount for the user, and a recipient of the insurance policy. The method also includes: creating, via the digital application, a user account with the identifiable information.

Further, the method includes: prompting, via the digital application, the user to provide answers to a questionnaire on how to distribute proceeds to one or more user-selected beneficiaries and to provide intentions via free-form text on how to distribute the proceeds to the one or more user-selected beneficiaries. Next, the method includes: receiving, from the user and via the digital application, the answers to the questionnaire and the intentions. Then, the method includes: utilizing a textual analytics algorithm of the digital application to: assess the free-form text intentions and convert the free-form text intentions to a common textual format.

The method may also include generating, via the digital application, a form using the identifiable information associated with the user, the answers to the questionnaire, and the intentions in the common textual format and transmitting the form to the one or more user-selected beneficiaries.

Optionally, the method may include: prompting, via the digital application, the user to provide statements indicating a reasoning behind the distribution of the proceeds to the one or more user-selected beneficiaries. Next, the method may include: receiving, from the user and via the digital application, the statements indicating the reasoning behind the distribution of the proceeds to the one or more user-selected beneficiaries. Then, the method may include: utilizing the textual analytics algorithm of the digital application to assess the statements and convert the statements to the common textual format. Next, the method may include: updating the form with the statements in the common textual format and transmitting the updated form to the one or more user-selected beneficiaries.

In some examples, the statements indicating the reasoning behind the distribution of the proceeds to the one or more user-selected beneficiaries further comprise words of advice or wisdom for the one or more user-selected beneficiaries. In other examples, the form further comprises a statement indicating that the form is not enforceable by law. In some examples, the statements indicating the reasoning behind the distribution of the proceeds to the one or more user-selected beneficiaries further comprise one or more intentions of the user as to how the proceeds are to be used.

In some examples, at least one of the one or more intentions are selected from a group of prewritten intentions, where the intentions may include: “Save this money and use it for my grandchildren's higher education tuition”; “Use this money to pay off your credit card bills”; “Use this money to pay off your debt”; “Save this money to pay present & future taxes”; “Use this money for a down payment on a new house”; “Use this money to fix the house”; “Use this money to prepay your mortgage”; “Use this money to pay future medical bills”; “Save this money for my grandchildren's future wedding”; “Create an Emergency Fund”; “Use this money for your retirement”; “Save this money and give it to my grandchildren when they reach certain ages”; “Pay off all your bills and then save the rest”; “Give some of this money to my church or favorite charity”; “Use this money to start a trust for your children”; “Use this money to get a will, power of attorney and a healthcare proxy”; “Use this money to increase your own life insurance”; “Use this money for single premium life insurance policies on your children”; “Use this money and put it into Long Term Care Insurance”; “Use this money to get a Disability Income Policy”; “Use this money and put it into investments for your future”; “Go to your CPA and ask for their professional advice on what to do with this money”; “Go to your Attorney and ask for their professional advice on what to do with this money”; “Save this money into FDIC interest accounts”; “Use this money to start the business that you were always dreaming of”; and/or “Use this money to buy the beach/mountain house that you were always dreaming of”. In some examples, the group of prewritten intentions describe how the proceeds are not to be used.

In other examples, the method may further include: receiving, from the user and via the digital application, a time interval by which the user is to be reminded to update the answers to the questionnaire and incorporating, via the digital application, the time interval into the form. In response to a conclusion of the time interval, the method may further include: transmitting, by the digital application, a notification to the user to update the answers to the questionnaire. In some examples, the notification comprises a textual, audio, and/or graphical notification sent to an email address of the user or the computing device of the user.

In some examples, the method may further include: receiving, from the user and via the digital application, updated answers to the questionnaire. In this scenario, the digital application may update the form based on the updated answers to the questionnaire and transmit the updated form to the one or more user-selected beneficiaries. In some examples, the method may further include: utilizing at least one artificial intelligence or machine learning algorithm of the digital application to provide suggestions to the user regarding additional considerations associated with the intentions.

A second embodiment of the present invention describes a computing device or an electronic device for providing one or more recipients with instructions on how to distribute proceeds with one or more named beneficiaries. The computing device or the electronic device includes at least a memory configured to store instructions associated with a digital application and a processor coupled to the memory. The processor executes the instructions associated with the digital application.

The digital application is configured to perform numerous process steps, such as: receive, from a user, identifiable information associated with the user and create a user account with the identifiable information. The digital application is also configured to: prompt the user to provide answers to a questionnaire on how to distribute proceeds to one or more user-selected beneficiaries, prompt the user to provide intentions via free-form text on how to distribute the proceeds to the one or more user-selected beneficiaries, and receive, from the user, the answers to the questionnaire and the intention. The digital application is further configured to: utilize a textual analytics algorithm of the digital application to: assess the intentions and convert the intentions to a common textual format.

The digital application is further configured to: utilize at least one artificial intelligence or machine learning algorithm of the digital application to provide suggestions to the user regarding additional considerations associated with the intentions; receive, from the user, an acceptance of the additional considerations associated with the intentions; generate a form using the identifiable information associated with the user, the answers to the questionnaire, the intentions, and the accepted additional considerations associated with the intentions in the common textual format; and transmit the form to the one or more user-selected beneficiaries.

In some examples, the digital application is further configured to: prompt the user to provide statements indicating a reasoning behind the distribution of the proceeds to the one or more user-selected beneficiaries. The statements may include one or more intentions of the user as to how the proceeds are to be used. Further, at least one of the one or more intentions is selected from a group of prewritten intentions, which may include: “Save this money and use it for my grandchildren's higher education tuition”; “Use this money to pay off your credit card bills”; “Use this money to pay off your debt”; “Save this money to pay present & future taxes”; “Use this money for a down payment on a new house”; “Use this money to fix the house”; “Use this money to prepay your mortgage”; “Use this money to pay future medical bills”; “Save this money for my grandchildren's future wedding”; “Create an Emergency Fund”; “Use this money for your retirement”; “Save this money and give it to my grandchildren when they reach certain ages”; “Pay off all your bills and then save the rest”; “Give some of this money to my church or favorite charity”; “Use this money to start a trust for your children”; “Use this money to get a will, power of attorney and a healthcare proxy”; “Use this money to increase your own life insurance”; “Use this money for single premium life insurance policies on your children”; “Use this money and put it into Long Term Care Insurance”; “Use this money to get a Disability Income Policy”; “Use this money and put it into investments for your future”; “Go to your CPA and ask for their professional advice on what to do with this money”; “Go to your Attorney and ask for their professional advice on what to do with this money”; “Save this money into FDIC interest accounts”; “Use this money to start the business that you were always dreaming of”; and/or “Use this money to buy the beach/mountain house that you were always dreaming of”.

A third embodiment of the present invention describes a computer program embodied in a non-transitory computer-readable medium comprising computer readable instructions, which when executed by a processor, cause the processor to provide one or more recipients with instructions on how to distribute proceeds with one or more named beneficiaries. The method steps include: receiving, from a user, identifiable information associated with the user and creating a user account with the identifiable information.

The method steps further include: prompting the user to provide answers to a questionnaire on how to distribute proceeds to one or more user-selected beneficiaries and to provide intentions via free-form text on how to distribute the proceeds to the one or more user-selected beneficiaries. The method steps also include receiving, from the user, the answers to the questionnaire and the intention and utilizing a textual analytics algorithm of the digital application to assess the intentions and convert the intentions to a common textual format.

Moreover, the method steps further include: utilizing at least one artificial intelligence or machine learning algorithm to provide suggestions to the user regarding additional considerations associated with the intentions; receiving, from the user, an acceptance of the additional considerations associated with the intentions; generating a form using the identifiable information associated with the user, the answers to the questionnaire, and the intentions in the common textual format; and transmitting the form to the one or more user-selected beneficiaries.

It is an object of the present invention to provide the method for providing one or more recipients with instructions on how to distribute proceeds with one or more named beneficiaries, wherein the method further includes inputting, using the graphical user interface, a length of time for the time interval.

It is an object of the present invention to provide the method for providing one or more recipients with instructions on how to distribute proceeds with one or more named beneficiaries, wherein the information pertaining to how to distribute the proceeds includes one or more intentions of the user as to how the proceeds are to be used.

It is an object of the present invention to provide the method for providing one or more recipients with instructions on how to distribute proceeds with one or more named beneficiaries, wherein at least one of the one or more intentions are selected from a group of prewritten intentions.

It is an object of the present invention to provide the method for providing one or more recipients with instructions on how to distribute proceeds with one or more named beneficiaries, wherein the information pertaining to how to distribute the proceeds includes one or more reasons as to why the proceeds are divided how that they are.

It is an object of the present invention to provide the method for providing one or more recipients with instructions on how to distribute proceeds with one or more named beneficiaries, wherein the method further includes creating a user account, using the graphical user interface, on the digital application.

It is an object of the present invention to provide the method for providing one or more recipients with instructions on how to distribute proceeds with one or more named beneficiaries, wherein the creating the user account further includes inputting identifiable information pertaining to the user.

It is an object of the present invention to provide the method for providing one or more recipients with instructions on how to distribute proceeds with one or more named beneficiaries, wherein the creating the user account further includes inputting information pertaining to one or more life insurance policies.

It is an object of the present invention to provide the method for providing one or more recipients with instructions on how to distribute proceeds with one or more named beneficiaries, wherein the proceeds are life insurance proceeds.

It is an object of the present invention to provide the method for providing one or more recipients with instructions on how to distribute proceeds with one or more named beneficiaries, wherein the form includes the time interval in which the information is to be updated.

### BRIEF DESCRIPTION OF THE DRAWINGS

FIGS. 1A-B show a method of instructing proceeds with one or more named beneficiaries according to an embodiment of the present invention.

FIG. 2 shows a system for preparing and updating instructions for proceeds with one or more named beneficiaries, according to an embodiment of the present invention.

FIG. 3 shows a form configured to aid in instructing proceeds with one or more named beneficiaries according to an embodiment of the present invention.

FIGS. 4A-4D show another example of the form, according to an embodiment of the present invention.

FIGS. 5A-5C show yet another example of the form, according to an embodiment of the present invention.

FIGS. 6A-6C show yet another example of the form, according to an embodiment of the present invention.

FIGS. 7A-7B show yet another example of the form, according to an embodiment of the present invention.

FIGS. 8A-8B show yet another example of the form, according to an embodiment of the present invention.

FIG. 9 depicts a block diagram of a computing device, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

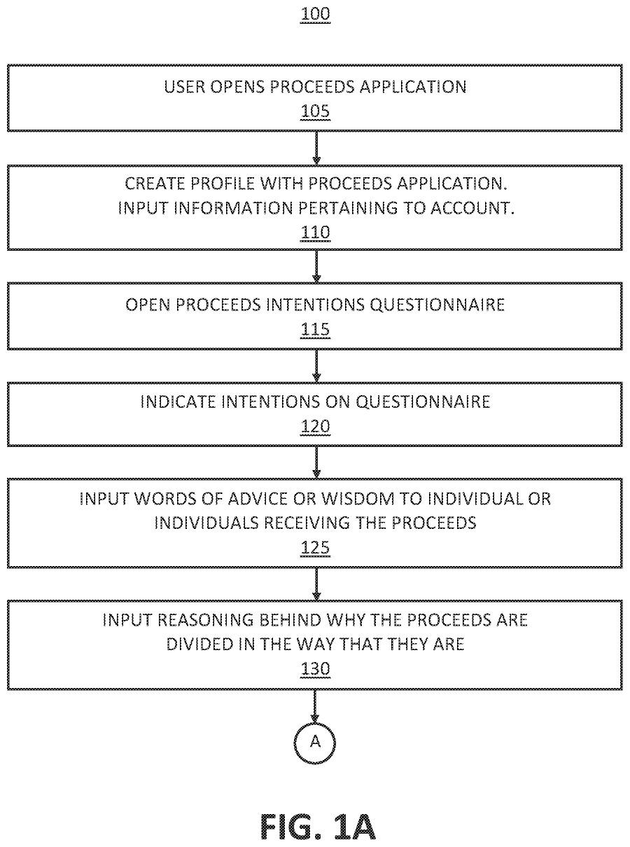

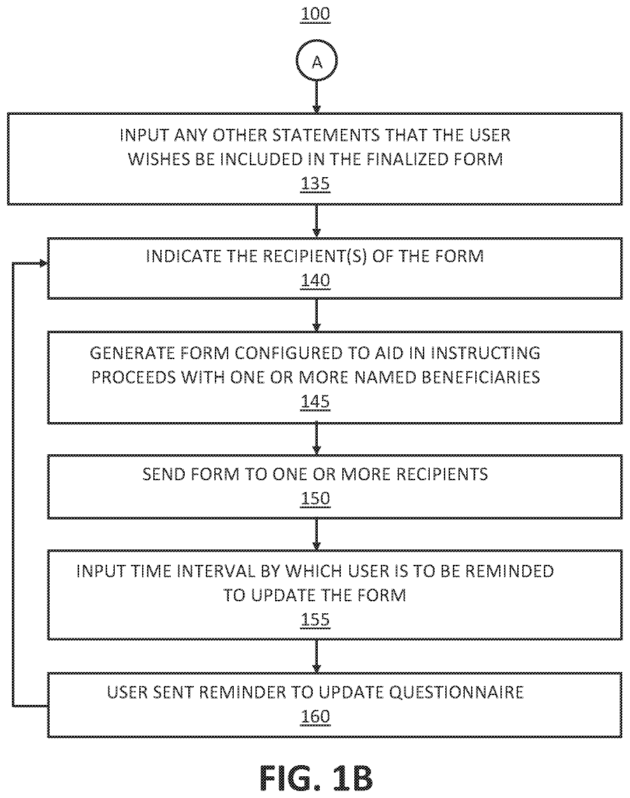

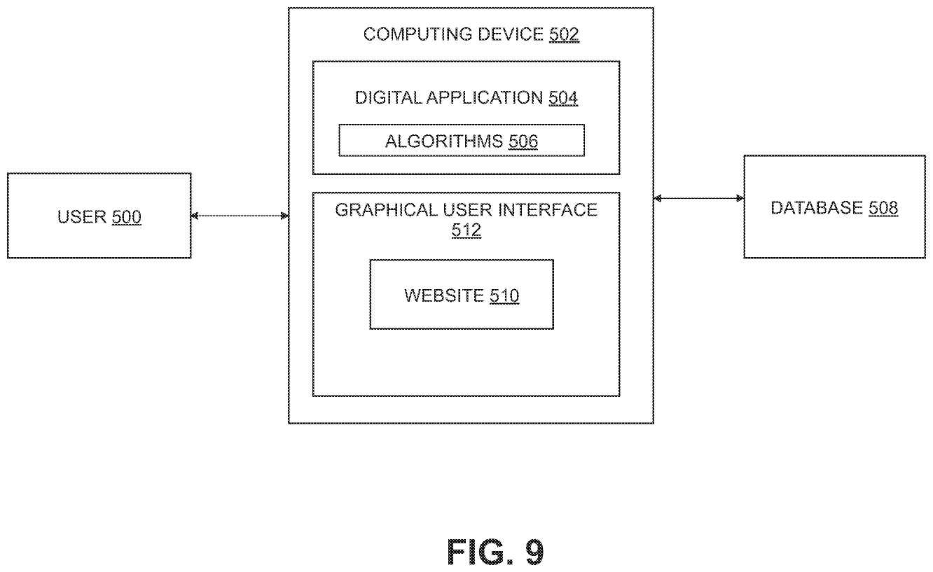

Referring now to FIGS. 1A-B, a method 100 of instructing proceeds with one or more named beneficiaries is illustratively depicted and FIG. 9 depicts a block diagram of a computing device 502, in accordance with an embodiment of the present invention. At step 105 of FIG. 1A, a user 500 logs into a digital application 504 (e.g., a proceeds application). According to an embodiment, the digital application 504 may include a website 510, a software program, or any other suitable application. It should be appreciated that in other examples, the digital application 504 may be an engine, a software program, a service, or a software platform executable on the computing device 502.

According to an embodiment the digital application 504 is configured to be run on the computing device 502. According to an embodiment, the computing device 502 may include any sort of computing device, such as: a desktop computer, a laptop computer, a tablet computer, a smartphone, and/or any other suitable electronic device. According to an embodiment, the proceeds are insurance proceeds. It is noted, however, that the proceeds may be any suitable proceeds in which one or more beneficiaries are named (e.g., annuities, IRA accounts, etc.).

The computing device 502 includes at least a graphical user interface (GUI) 512 and a virtual private network (VPN). The GUI 512 is adapted to: provide a user with functionality to log into to access the website 510 or the software program and receive, from the user 500, login information associated with a user account. The VPN manages the user's 500 connection to and access with the Internet.

It should be appreciated that the digital application 504 includes one or more algorithms 506 (e.g., artificial intelligence, machine learning algorithms, and/or textual analytics algorithms). As described herein, “machine learning” is a subset of artificial intelligence and is the study of computer algorithms that improve automatically through experience. Machine learning algorithms build a mathematical model based on sample data (or “training data”) in order to make predictions or decisions, without being explicitly programmed to do so. Algorithms for text analytics incorporate a variety of techniques such as text classification, categorization, and clustering. Text analytics algorithms seek to uncover hidden relationships, trends, and patterns.

According to an embodiment, at step 110 of FIG. 1A, the user 500 creates an account using the digital application 504. According to an embodiment, creating the account includes inputting identifiable information pertaining to the user 500. According to an embodiment, the identifiable information may include the user's 500 name, address, email address, phone number, insurance provider, insurance or other account information, insurance or other policy or account number, insurance or other policy or account amount, the recipient or recipients of insurance policy or other suitable policy/account, and/or any other relevant identifiable information. According to an embodiment, the account on the digital application 504 connects to the website/database/etc. for the provider of the original policy. According to an embodiment, the digital application 504 is incorporated into an application for the provider of the policy. According to an embodiment, the digital application 504 is separate and apart from any applications for the provider of the policy.

At step 115 of FIG. 1A, the user 500 opens a questionnaire containing information relating to the user's 500 intentions as to how the recipient (the beneficiary of the proceeds) is to use the proceeds. According to an embodiment, at step 120 of FIG. 1A, the user 500 fills in a portion of the questionnaire indicating the user's 500 stated intentions. According to an embodiment, the user 500 is able to write his/her intentions from scratch (e.g., via free form text), such as: “Give Molly Smith my vehicle.” Then, the one or more algorithms 506 (e.g., one or more textual analytics algorithms) assess the user's 500 stated intentions and convert the user's 500 intentions into a common textual format. Next, the one or more algorithms 506 (e.g., the artificial intelligence and/or machine learning algorithms) provide suggestions on how to proceed and/or provide suggestions to the user 500 regarding additional considerations associated with the intentions. For example, the artificial intelligence and/or machine learning algorithms may suggest to the user 500 to inform Molly Smith to transfer the title to the vehicle into her name or obtain vehicle insurance.

According to an embodiment, the user 500 is able to select one or more of his/her intentions from a prewritten set of intentions. According to an embodiment, the prewritten set of intentions may include, e.g.: “Save this money and use it for my grandchildren's higher education tuition”; “Use this money to pay off your credit card bills”; “Use this money to pay off your debt”; “Save this money to pay present & future taxes”; “Use this money for a down payment on a new house”; “Use this money to fix the house”; “Use this money to prepay your mortgage”; “Use this money to pay future medical bills”; “Save this money for my grandchildren's future wedding”; “Create an Emergency Fund”; “Use this money for your retirement”; “Save this money and give it to my grandchildren when they reach certain ages”; “Pay off all your bills and then save the rest”; “Give some of this money to my church or favorite charity”; “Use this money to start a trust for your children”; “Use this money to get a will, power of attorney and a healthcare proxy”; “Use this money to increase your own life insurance”; “Use this money for single premium life insurance policies on your children”; “Use this money and put it into Long Term Care Insurance”; “Use this money to get a Disability Income Policy”; “Use this money and put it into investments for your future”; “Go to your CPA and ask for their professional advice on what to do with this money”; “Go to your Attorney and ask for their professional advice on what to do with this money”; “Save this money into FDIC interest accounts”; “Use this money to start the business that you were always dreaming of”; “Use this money to buy the beach/mountain house that you were always dreaming of”; and/or any other relevant intentions on how to use and/or not use the money. According to an embodiment, the prewritten intentions may also include intentions of things for which the money is not to be used.

According to an embodiment, at step 125 of FIG. 1A, the user 500 optionally inputs, into the questionnaire, words of advice or wisdom to the person or persons receiving the money. These words of advice may include, e.g., “please be smart with the money”, “please perform any relevant research prior to spending the money”, “please enjoy the money”, and/or any other relevant words of advice or wisdom.

According to an embodiment, at step 130 of FIG. 1A, the user 500 optionally inputs, into the questionnaire, a statement indicating the reasoning behind why the proceeds are divided the way that they are. This statement may include an introductory phrase, such as “I have divided my money up this way because”. It is noted, however, that any suitable language may be used, according to various embodiments of the present invention, to convey the reasoning of the user. The user 500 may optionally, at step 135 of FIG. 1B, input any other statements the user wishes to include. These statements may include, e.g., “I love you very much and please be smart with the money that I am leaving you” and/or any other statements the user wishes to include.

According to an embodiment, at step 140 of FIG. 1B, the user 500 indicates the recipient or recipients of the user's intentions. The recipient or recipients may be the user's attorney, designated executor, the person or persons receiving the proceeds (the beneficiary or beneficiaries), and/or anyone else the user desires to receive the intentions. At step 145 of FIG. 1B, using the user's 500 answers to the questionnaire and the name(s) of the recipient(s), the digital application 504 generates a form configured to aid in instructing the beneficiary or beneficiaries on how to use the proceeds. According to an embodiment, the form indicates the intentions and the recipient(s). According to an embodiment, the form further includes a statement indicating that the form is not enforceable by law. According to an embodiment, the form further includes the date on which the information was provided by the user.

After the form is generated, the one or more algorithms 506 (e.g., the textual analytics algorithms) convert all text into a common format. Then, the digital application 504, at step 150 of FIG. 1B, sends the form to the one or more recipients. According to an embodiment, the user 500 inputs information the digital application 504 may use to send the form to the recipient, such as, e.g., an email address.

According to an embodiment, at step 155 of FIG. 1B, the user 500 inputs, into the digital application 504, a time interval by which the user 500 is to be reminded to update the answers given to the questionnaire. According to an embodiment, the time interval may be, e.g., weekly, monthly, annually, or any other suitable timeframe. According to an embodiment, the digital application 504 automatically sets a time interval. According to an embodiment, the form includes the time interval, stating, e.g., “This form will be sent to the originator every 24 months to be updated”, or any other suitable language.

At the conclusion of the time interval, the user 500, at step 160 of FIG. 1B, is reminded to update the answers to the questionnaire. According to an embodiment, the reminder may be a notification. The notification is a textual, audio, and/or graphical notification sent to an email address of the user 500 or the computing device 502 of the user 500. It is noted, however, that any suitable form of notification, such as an audible alarm, a visual alarm, a vibrational alarm, etc. may be used to remind the user 500 to update the questionnaire. Once the questionnaire is updated, the digital application 504, at step 145 of FIG. 1B, generates the form configured to aid in instructing beneficiaries on how to use proceeds.

Since, oftentimes, the intentions of the deceased are not known or change frequently, confusion, arguments, and discontent between those who have survived the deceased as to what should be done with the items, money, etc. often arises. This is a common and recurring problem in this field that the present invention cures. Furthermore, by not only readily and efficiently enabling users to input their intentions, but also by enabling them to update their intentions and automatically sending reminders to update their intentions, the present invention is an improvement upon the existing technology.

Even if instructions are left, the instructions may be old, and the deceased's true intentions at the time of his/her death may be in question. Questions as to the true intent may also lead to further discontent between those that survive the deceased.

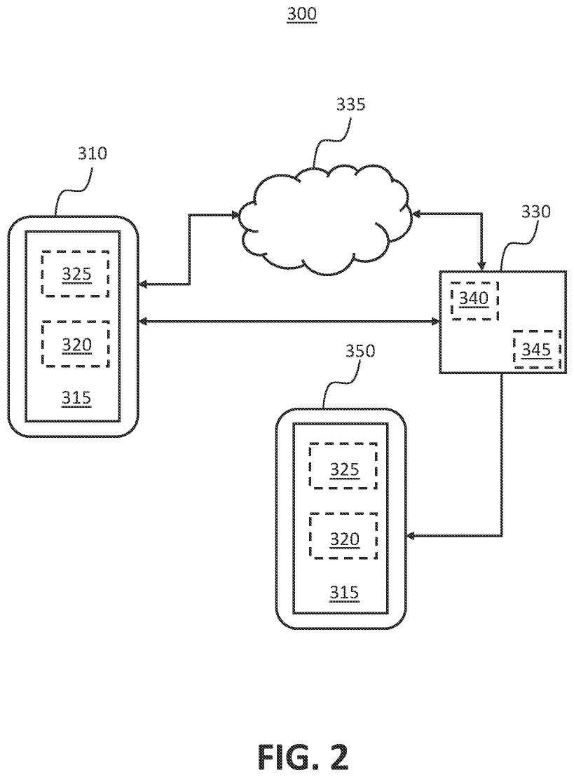

Referring now to FIG. 2, a system 300 for preparing and updating instructions for how named beneficiaries should use proceeds is illustratively depicted, in accordance with an embodiment of the present invention. According to an embodiment, the system 300 includes an electronic device 310 on which the user 500 may open the digital application 504. According to an embodiment, the electronic device 310 may include a graphical user interface 315, a processor 320, and/or a memory 325. According to an embodiment, the user may access the digital application 504 on the electronic device 310 and communicate with the digital application 504 using the graphical user interface 315. According to an embodiment, the electronic device 310 may be a desktop computer, a laptop computer, a tablet computer, a smartphone, and/or any other suitable electronic device 310.

According to an embodiment, the user 500 inputs data into the digital application 504. According to an embodiment, this data is then sent to one or more remote servers 330. According to an embodiment, the electronic device 310 is coupled to the one or more remote servers 330 via a wired and/or wireless connection (such as via cloud computing 335). According to an embodiment, the one or more remote servers 330 include at least one processor 340 and/or at least one memory 345, configured to store the information input into the digital application 504 using the graphical user interface 315. In some examples, one or more databases 508 (of FIG. 9) store information described herein. According to an embodiment, the electronic device 310 and/or the remote server 330 are configured to create the form configured to aid in instructing named beneficiaries on how to use proceeds using the information inputted into the digital application 504.

According to an embodiment, after a predetermined time interval has expired, the one or more remote servers 330 sends a signal to the user's electronic device 310. The signal is configured to cause the electronic device 310 to alert the user 500 that it is time to update the form. According to an embodiment, once the form is created, it is sent to the one or more designated recipients. According to an embodiment, the form is sent to an electronic device 350 of the recipient.

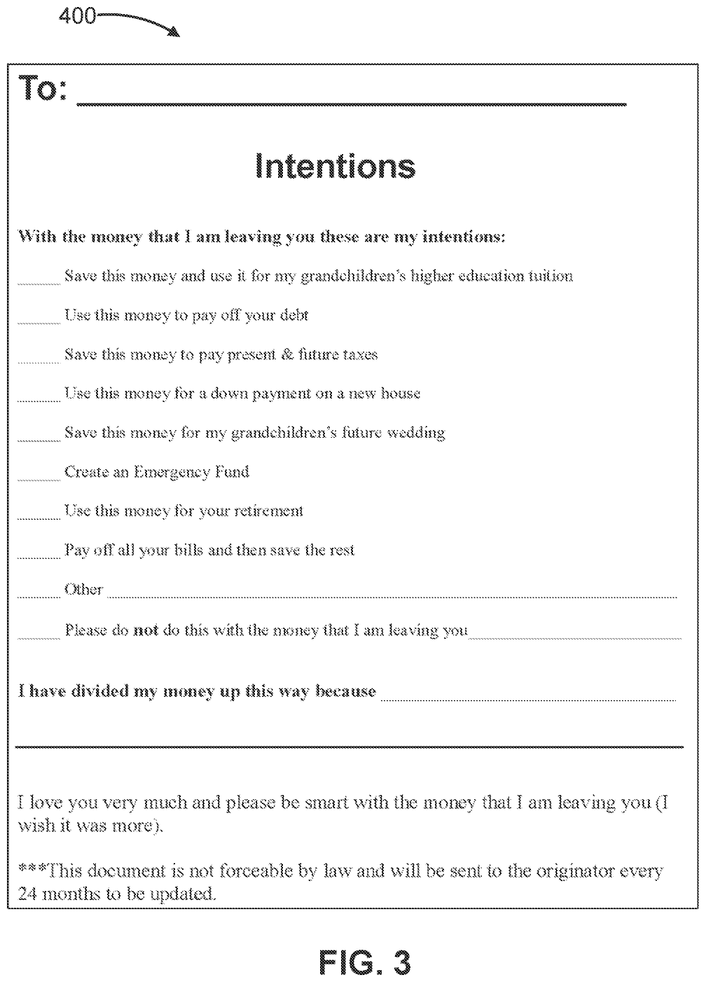

Referring now to FIG. 3, a form 400 configured to aid in instructing proceeds with one or more named beneficiaries is illustratively depicted, in accordance with an embodiment of the present invention.

According to an embodiment, the form 400 indicates the recipient of the intentions. For example, the form 400 may include a section stating “To:” followed by the recipient. The recipient may be, e.g., the recipient of the money, a trustee of the money, a legal guardian of the recipient of the money, an attorney in charge of the estate of the insured person, and/or any other suitable person. According to an embodiment, the form 400 is properly labeled. For example, the form 400 may indicate that the title of the form 400 is “Intentions”. It is noted, however, that any suitable title conveying the content of the form 400 may suffice.

According to an embodiment, the form 400 includes one or more stated intentions for the money. According to an embodiment, the intentions may include: “Save this money and use it for my grandchildren's higher education tuition”; “Use this money to pay off your credit card bills”; “Use this money to pay off your debt”; “Save this money to pay present & future taxes”; “Use this money for a down payment on a new house”; “Use this money to fix the house”; “Use this money to prepay your mortgage”; “Use this money to pay future medical bills”; “Save this money for my grandchildren's future wedding”; “Create an Emergency Fund”; “Use this money for your retirement”; “Save this money and give it to my grandchildren when they reach certain ages”; “Pay off all your bills and then save the rest”; “Give some of this money to my church or favorite charity”; “Use this money to start a trust for your children”; “Use this money to get a will, power of attorney and a healthcare proxy”; “Use this money to increase your own life insurance”; “Use this money for single premium life insurance policies on your children”; “Use this money and put it into Long Term Care Insurance”; “Use this money to get a Disability Income Policy”; “Use this money and put it into investments for your future”; “Go to your CPA and ask for their professional advice on what to do with this money”; “Go to your Attorney and ask for their professional advice on what to do with this money”; “Save this money into FDIC interest accounts”; “Use this money to start the business that you were always dreaming of”; “Use this money to buy the beach/mountain house that you were always dreaming of”; and/or any other relevant intentions on how to use and/or not use the money. According to an embodiment, the prewritten intentions may also include intentions of things for which the money is not to be used. For example, the form 400 may include language such as “Please do not do this with the money that I am leaving you”, followed by the relevant things not to do with the money. It is noted, however, that any suitable wordage may be used to convey the intentions of the user, while maintaining the spirit of the present invention.

According to an embodiment, the intentions may include words of advice or wisdom to the person or persons receiving the money. These words of advice may be, e.g., “please be smart with the money”, “please perform any relevant research prior to spending the money”, “please enjoy the money”, and/or any other relevant words of advice.

According to an embodiment, the form 400 includes a statement indicating the document is not enforceable by law. Furthermore, according to an embodiment, the may indicate the time interval in which the form 400 is to be updated. For example, the form 400 may include a statement such as: “This document is not forcible by law and will be sent to the originator every 24 months to be updated”.

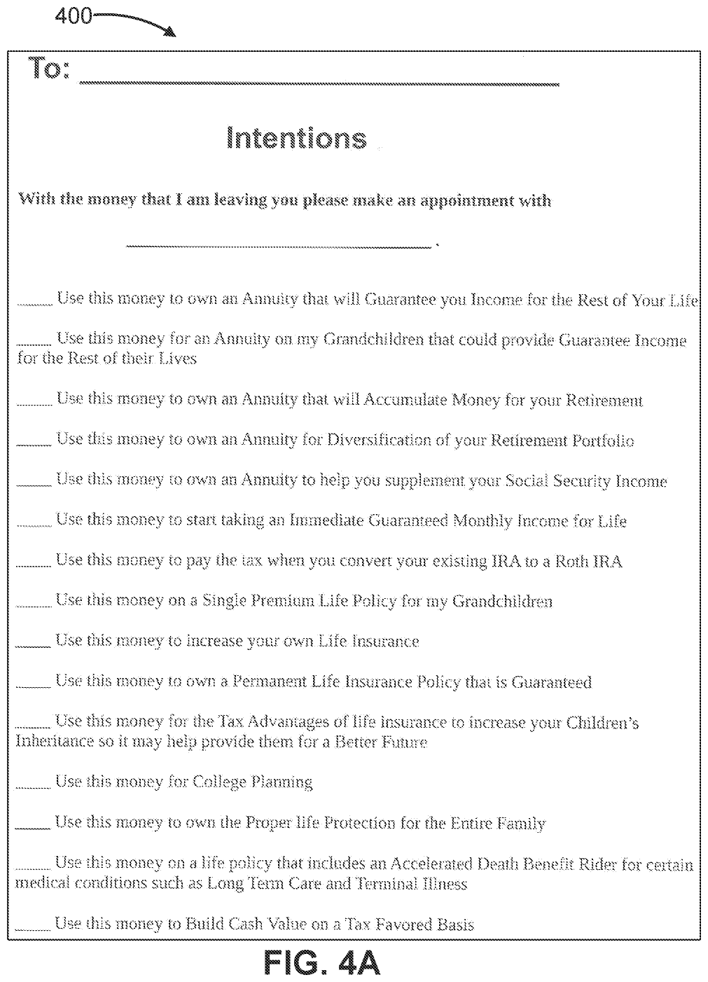

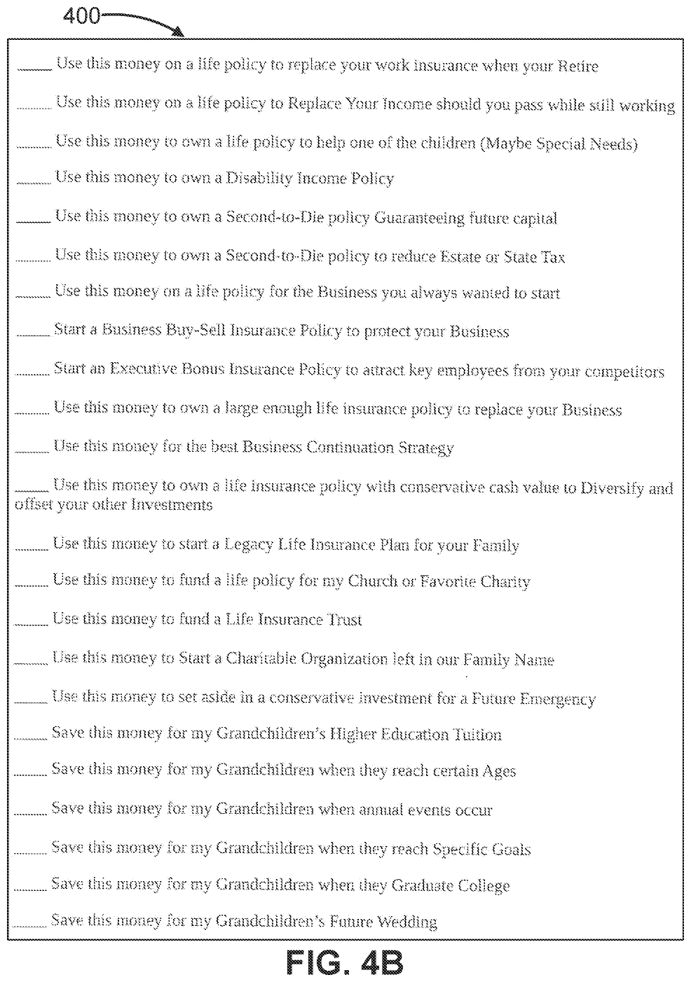

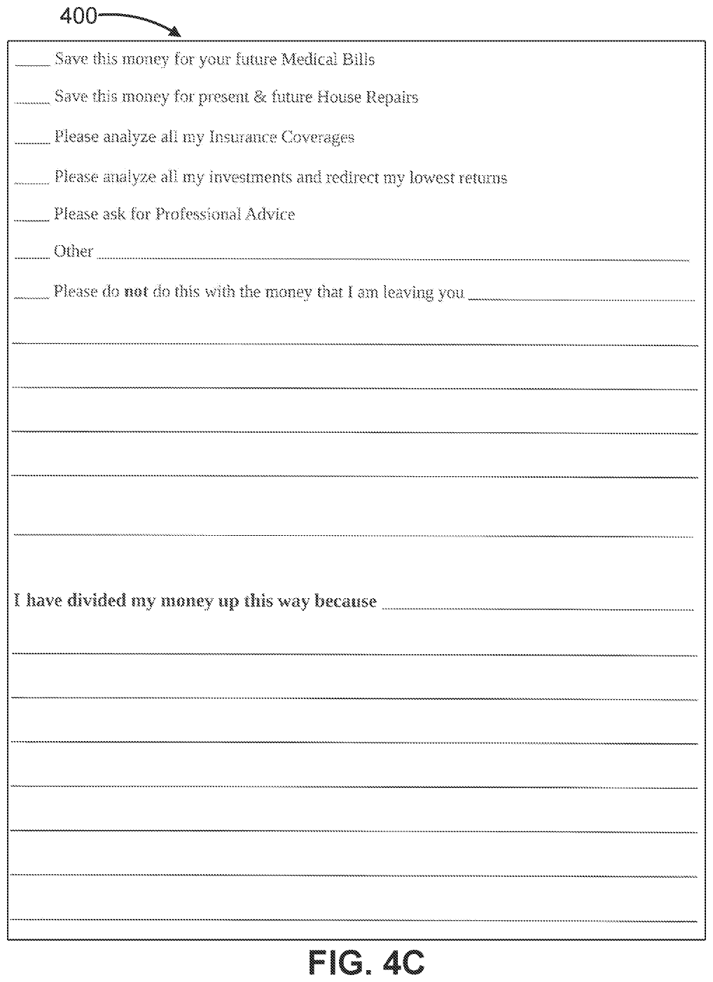

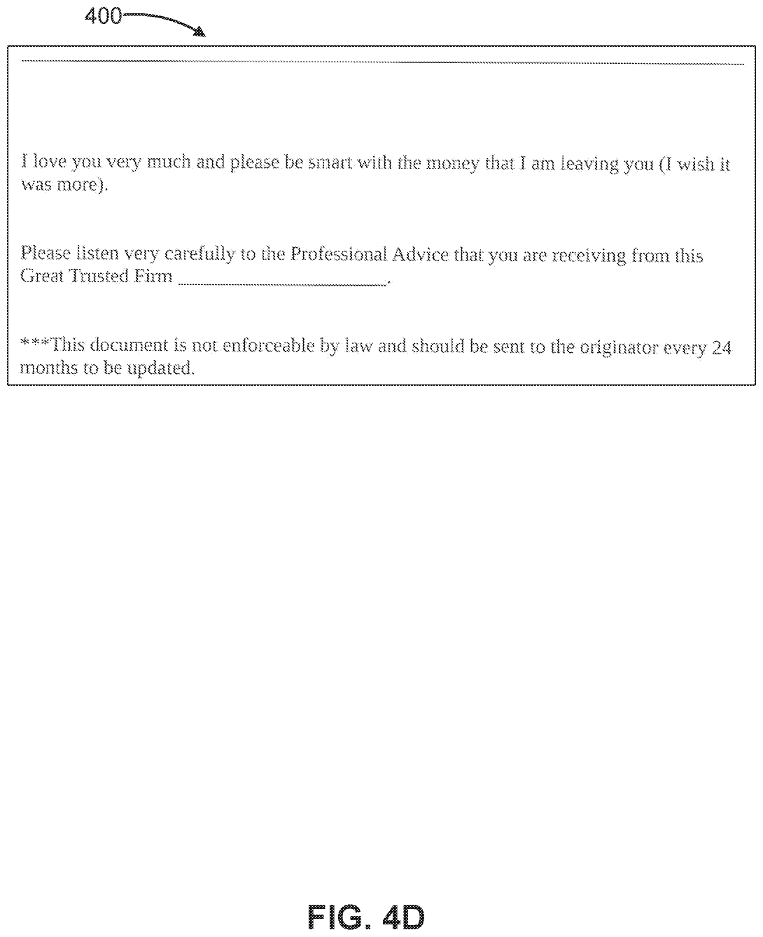

Referring now to FIGS. 4A-4D, components of the form 400 may be used to capture and record instructions related to an insurance related matter, in accordance with an embodiment of the present invention. The insurance related matter may include a windfall from an insurance related payment. The instructions may be provided to an insurance entity for execution in relation to the legal matter.

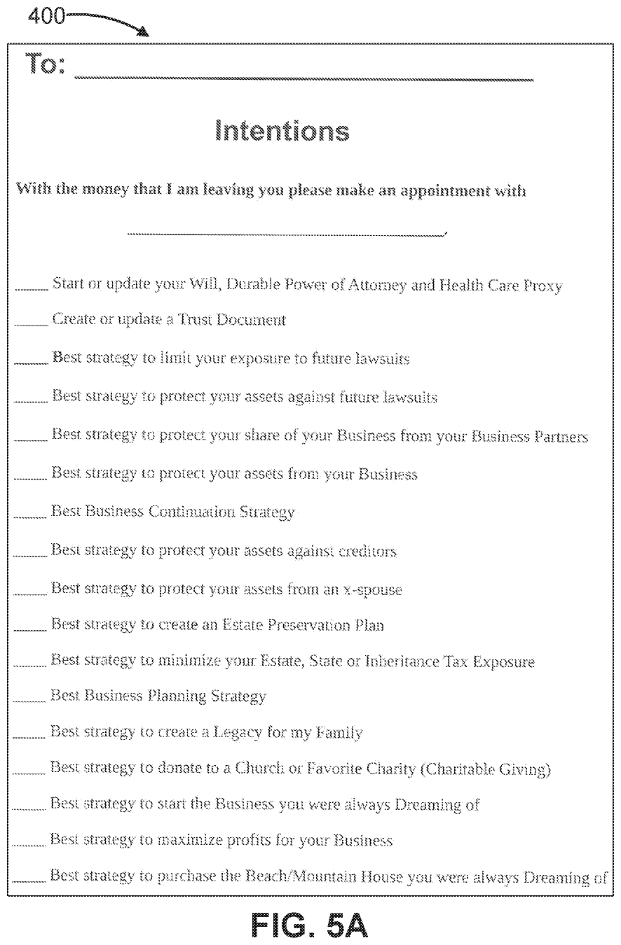

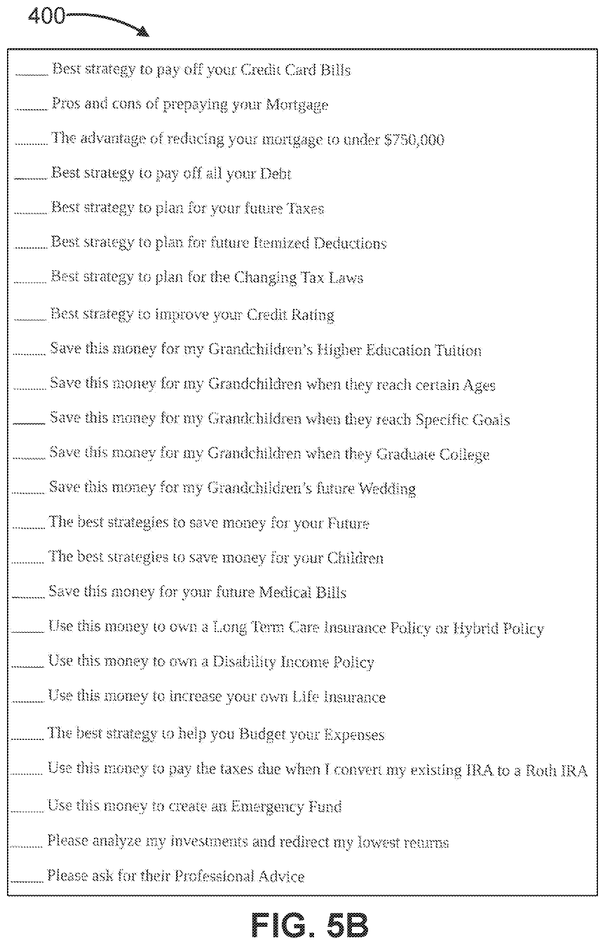

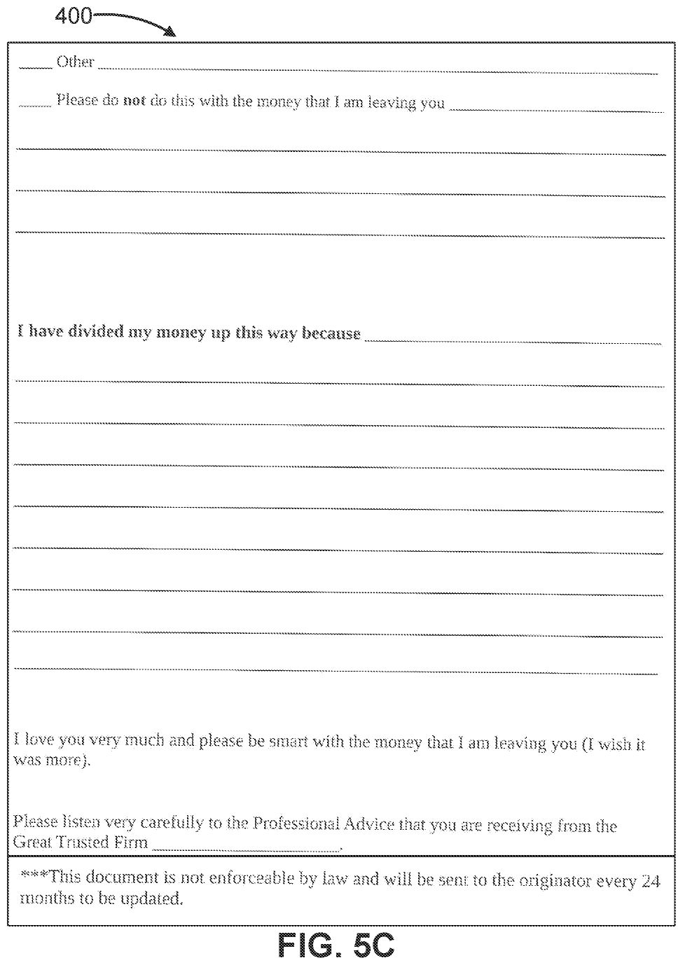

Referring now to FIGS. 5A-5C, components of the form 400 may be used to capture and record instructions related to a legal matter, in accordance with an embodiment of the present invention. The legal matter may include a windfall from a lawsuit. The instructions may be provided to a law firm for execution in relation to the legal matter.

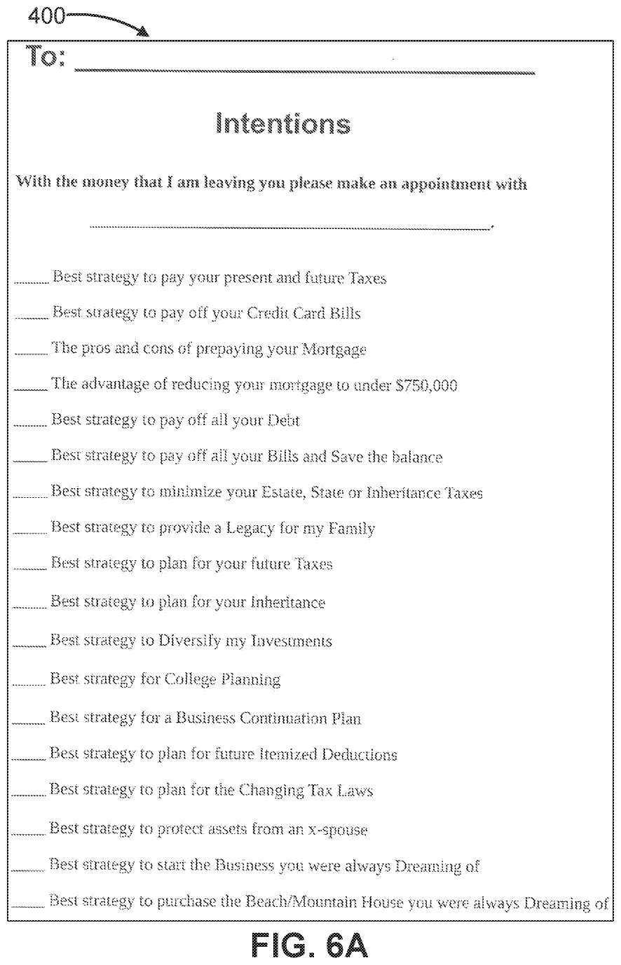

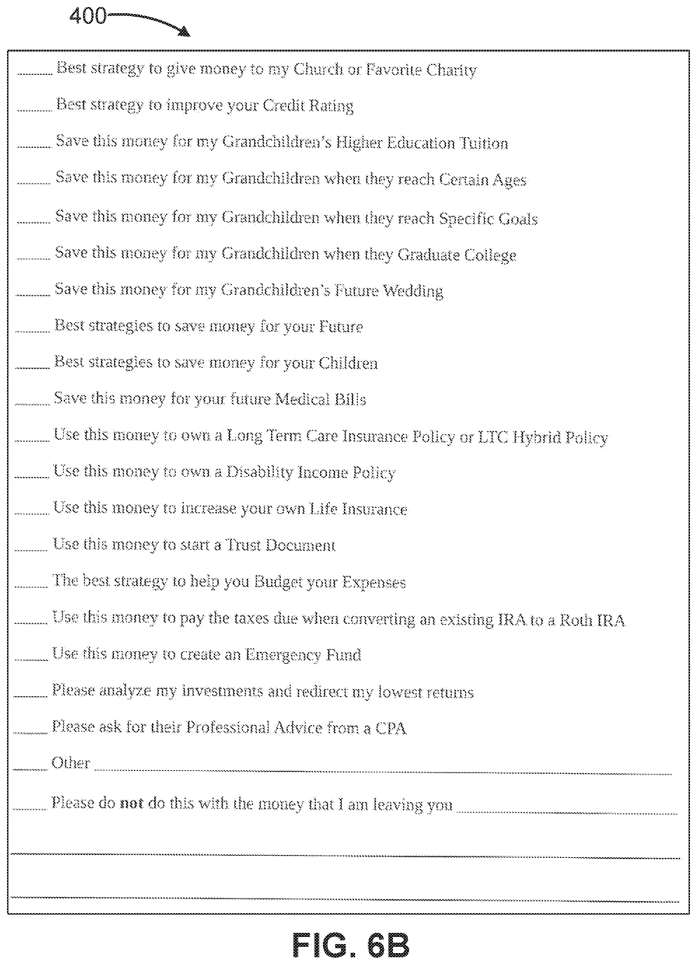

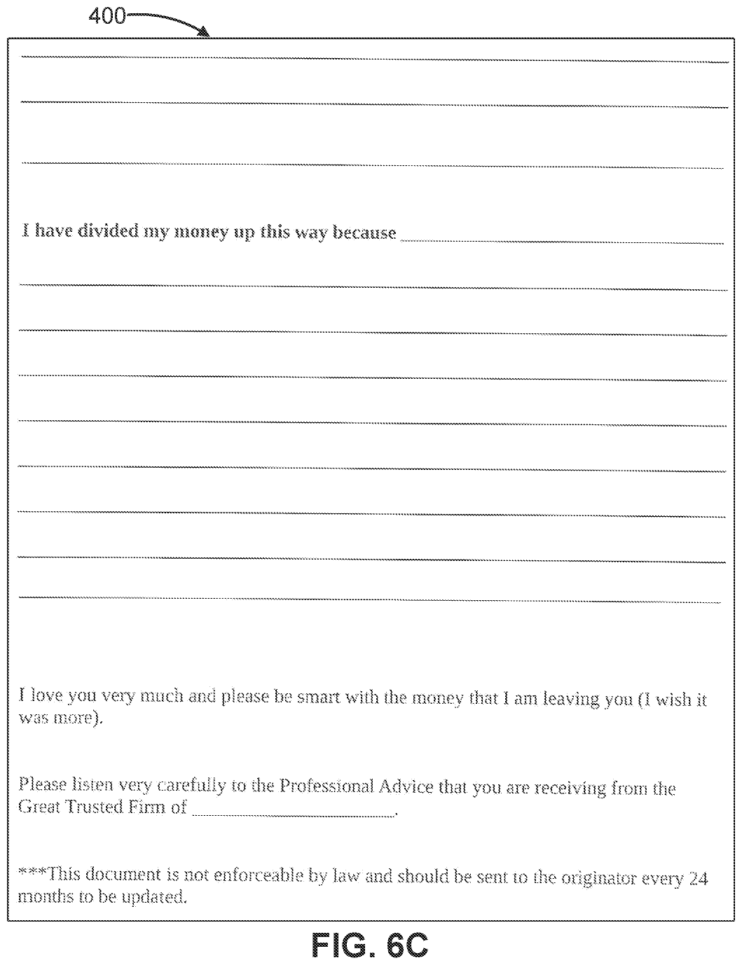

Referring now to FIGS. 6A-6C, components of the form 400, may be used to capture and record instructions related to financial matter, in accordance with an embodiment of the present invention. The financial matter may include a tax related transaction. The instructions may be provided to a financial entity for execution in relation to the financial matter.

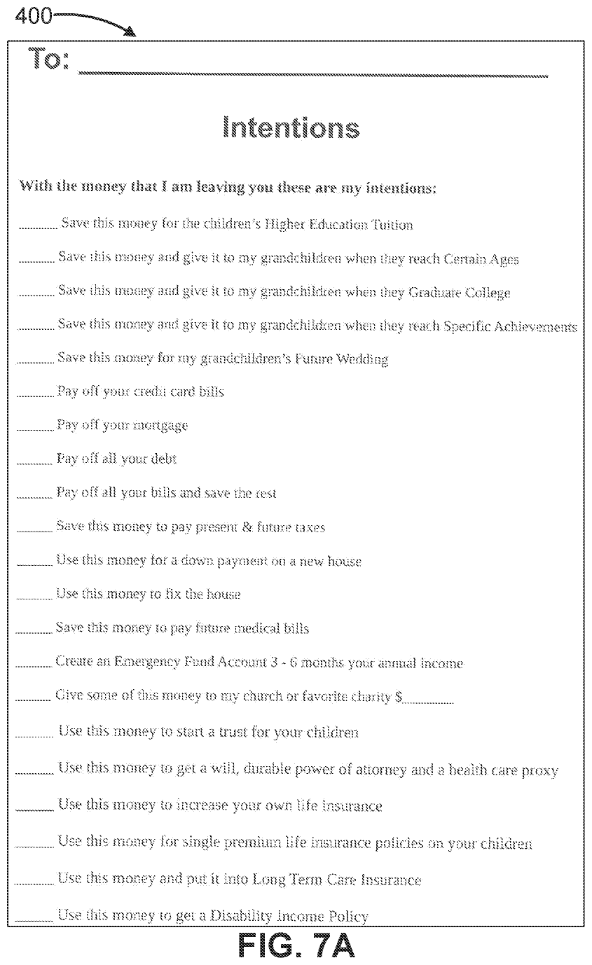

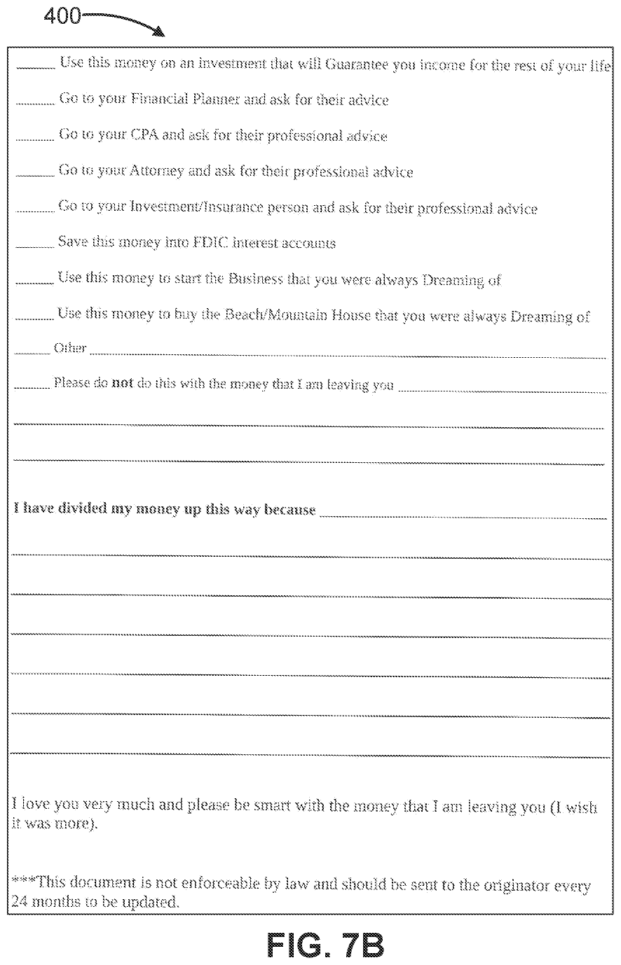

Referring now to FIGS. 7A-7B, components of the form 400 may be used to capture and record instructions related to a public matter, in accordance with an embodiment of the present invention. The public matter may include asset disbursement related tasks. The instructions may be provided to a member of the public for execution in relation to the public matter.

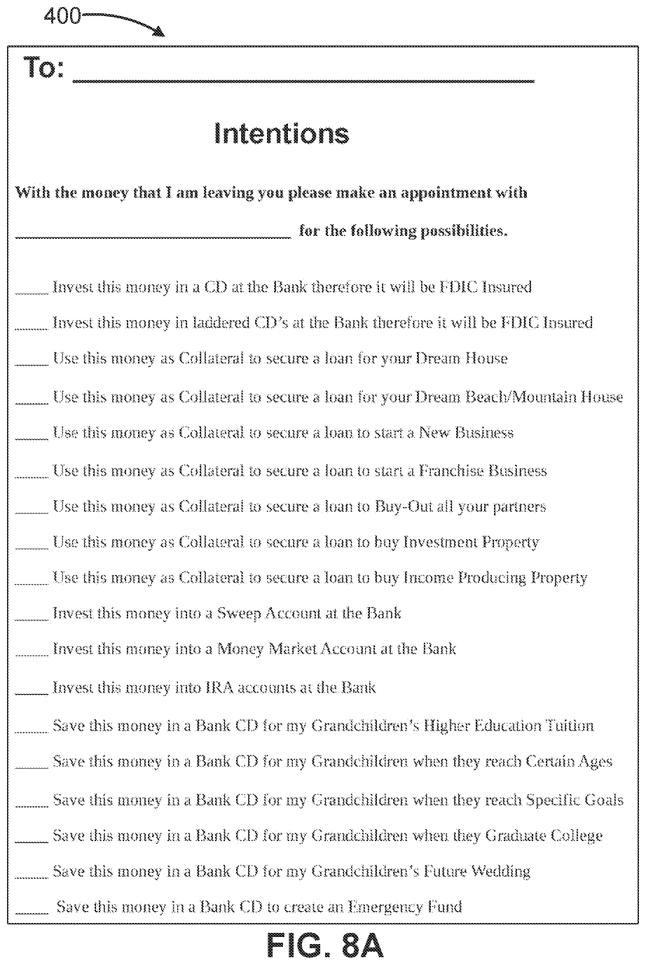

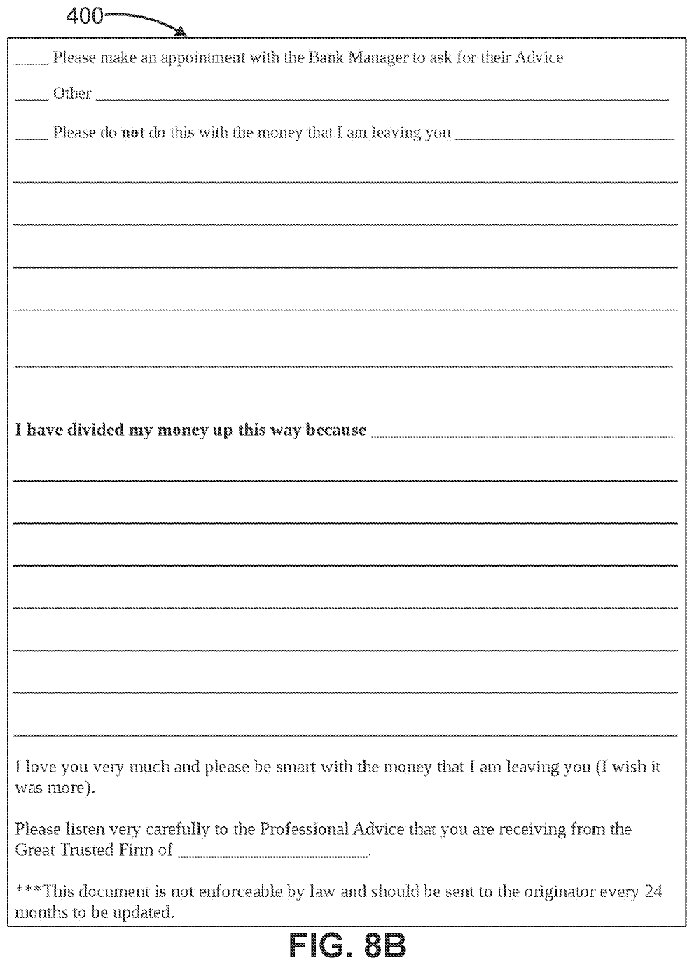

Referring now to FIGS. 8A-8B, components of the form 400 may be used to capture and record instruction related to a banking related matter, in accordance with an embodiment of the present invention. The banking related matter may include bank account related tasks. The instructions may be provided to a banking institution or other entity for execution in relation to the banking related matter.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo™ DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor, Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA (PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like, wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HCI6 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XPNista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery (UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component, however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by a computing device for providing one or more recipients with instructions on how to distribute proceeds with one or more named beneficiaries, the method comprising:
receiving, from a user and via a digital application executable on the computing device, identifiable information associated with the user;
creating, via the digital application, a user account with the identifiable information;
prompting, via the digital application, the user to provide answers to a questionnaire on how to distribute proceeds to one or more user-selected beneficiaries;
prompting, via the digital application, the user to provide intentions via free-form text on how to distribute the proceeds to the one or more user-selected beneficiaries;
receiving, from the user and via the digital application, the answers to the questionnaire and the intentions;
utilizing a textual analytics algorithm of the digital application to:
assess the intentions; and
convert the intentions to a common textual format;
generating, via the digital application, a form using the identifiable information associated with the user, the answers to the questionnaire, and the intentions in the common textual format; and
transmitting the form to the one or more user-selected beneficiaries.

2. The method of claim 1, wherein the identifiable information includes at least a name of the user, an address of the user, an email address of the user, an insurance provider associated with an insurance policy for the user, the insurance policy number for the user, an insurance policy amount for the user, and a recipient of the insurance policy.

3. The method of claim 1, further comprising:
prompting, via the digital application, the user to provide statements indicating a reasoning behind the distribution of the proceeds to the one or more user-selected beneficiaries.

4. The method of claim 3, further comprising:
receiving, from the user and via the digital application, the statements indicating the reasoning behind the distribution of the proceeds to the one or more user-selected beneficiaries;
utilizing the textual analytics algorithm to:
assess the statements; and
convert the statements to the common textual format;
updating the form with the statements in the common textual format; and
transmitting the updated form to the one or more user-selected beneficiaries.

5. The method as recited in claim 3, wherein the statements further comprise words of advice or wisdom for the one or more user-selected beneficiaries.

6. The method as recited in claim 1, wherein the form further comprises a statement indicating that the form is not enforceable by law.

7. The method as recited in claim 1, wherein the proceeds are life insurance proceeds.

8. The method of claim 3, wherein the statements further comprise one or more intentions of the user as to how the proceeds are to be used.

9. The method as recited in claim 8, wherein at least one of the one or more intentions are selected from a group of prewritten intentions.

10. The method as recited in claim 9, wherein each intention of the group of prewritten intentions are selected from the group consisting of: “Save this money and use it for my grandchildren's higher education tuition”; “Use this money to pay off your credit card bills”; “Use this money to pay off your debt”; “Save this money to pay present & future taxes”; “Use this money for a down payment on a new house”; “Use this money to fix the house”; “Use this money to prepay your mortgage”; “Use this money to pay future medical bills”; “Save this money for my grandchildren's future wedding”; “Create an Emergency Fund”; “Use this money for your retirement”; “Save this money and give it to my grandchildren when they reach certain ages”; “Pay off all your bills and then save the rest”; “Give some of this money to my church or favorite charity”; “Use this money to start a trust for your children”; “Use this money to get a will, power of attorney and a healthcare proxy”; “Use this money to increase your own life insurance”; “Use this money for single premium life insurance policies on your children”; “Use this money and put it into Long Term Care Insurance”; “Use this money to get a Disability Income Policy”; “Use this money and put it into investments for your future”; “Go to your CPA and ask for their professional advice on what to do with this money”; “Go to your Attorney and ask for their professional advice on what to do with this money”; “Save this money into FDIC interest accounts”; “Use this money to start the business that you were always dreaming of”; and “Use this money to buy the beach/mountain house that you were always dreaming of”.

11. The method as recited in claim 9, wherein the group of prewritten intentions describe how the proceeds are not to be used.

12. The method of claim 1, further comprising
receiving, from the user and via the digital application, a time interval by which the user is to be reminded to update the answers to the questionnaire; and
incorporating, via the digital application, the time interval into the form.

13. The method of claim 12, further comprising:
in response to a conclusion of the time interval, transmitting, by the digital application, a notification to the user to update the answers to the questionnaire.

14. The method of claim 13, wherein the notification comprises an email notification or an alarm notification sent to the computing device of the user.

15. The method of claim 13, further comprising:
receiving, from the user and via the digital application, updated answers to the questionnaire;
updating the form based on the updated answers to the questionnaire; and
transmitting the updated form to the one or more user-selected beneficiaries.

16. The method of claim 1, further comprising:
utilizing at least one artificial intelligence or machine learning algorithm of the digital application to provide suggestions to the user regarding additional considerations associated with the intentions.

17. An electronic device for providing one or more recipients with instructions on how to distribute proceeds with one or more named beneficiaries, the electronic device comprising:
a memory configured to store instructions associated with a digital application, and
a processor coupled to the memory, the processor executing the instructions associated with the digital application, wherein the digital application is configured to:
receive, from a user, identifiable information associated with the user;
create a user account with the identifiable information;
prompt the user to provide answers to a questionnaire on how to distribute proceeds to one or more user-selected beneficiaries;
prompt the user to provide intentions via free-form text on how to distribute the proceeds to the one or more user-selected beneficiaries;
receive, from the user, the answers to the questionnaire and the intentions;
utilize a textual analytics algorithm of the digital application to:
assess the intentions; and
convert the intentions to a common textual format;
utilize at least one artificial intelligence or machine learning algorithm of the digital application to provide suggestions to the user regarding additional considerations associated with the intentions;
receive, from the user, an acceptance of the additional considerations associated with the intentions;
generate a form using the identifiable information associated with the user, the answers to the questionnaire, the intentions, and the accepted additional considerations associated with the intentions in the common textual format; and
transmit the form to the one or more user-selected beneficiaries.

18. The electronic device of claim 17, wherein the digital application is further configured to:
prompt the user to provide statements indicating a reasoning behind the distribution of the proceeds to the one or more user-selected beneficiaries,
wherein the statements indicating the reasoning behind the distribution of the proceeds to the one or more user-selected beneficiaries further comprise one or more intentions of the user as to how the proceeds are to be used, and
wherein at least one of the one or more intentions are selected from a group of prewritten intentions.

19. The electronic device of claim 18, wherein each intention of the group of prewritten intentions are selected from the group consisting of: “Save this money and use it for my grandchildren's higher education tuition”; “Use this money to pay off your credit card bills”; “Use this money to pay off your debt”; “Save this money to pay present & future taxes”; “Use this money for a down payment on a new house”; “Use this money to fix the house”; “Use this money to prepay your mortgage”; “Use this money to pay future medical bills”; “Save this money for my grandchildren's future wedding”; “Create an Emergency Fund”; “Use this money for your retirement”; “Save this money and give it to my grandchildren when they reach certain ages”; “Pay off all your bills and then save the rest”; “Give some of this money to my church or favorite charity”; “Use this money to start a trust for your children”; “Use this money to get a will, power of attorney and a healthcare proxy”; “Use this money to increase your own life insurance”; “Use this money for single premium life insurance policies on your children”; “Use this money and put it into Long Term Care Insurance”; “Use this money to get a Disability Income Policy”; “Use this money and put it into investments for your future”; “Go to your CPA and ask for their professional advice on what to do with this money”; “Go to your Attorney and ask for their professional advice on what to do with this money”; “Save this money into FDIC interest accounts”; “Use this money to start the business that you were always dreaming of”; and “Use this money to buy the beach/mountain house that you were always dreaming of”.

20. A computer program embodied in a non-transitory computer-readable medium comprising computer readable instructions, which when executed by a processor, cause the processor to provide one or more recipients with instructions on how to distribute proceeds with one or more named beneficiaries comprising the steps of:
receiving, from a user, identifiable information associated with the user;
creating a user account with the identifiable information;
prompting the user to provide answers to a questionnaire on how to distribute proceeds to one or more user-selected beneficiaries;
prompting the user to provide intentions via free-form text on how to distribute the proceeds to the one or more user-selected beneficiaries;
receiving, from the user, the answers to the questionnaire and the intentions;
utilizing a textual analytics algorithm to:
assess the intentions; and
convert the intentions to a common textual format;
utilizing at least one artificial intelligence or machine learning algorithm to provide suggestions to the user regarding additional considerations associated with the intentions;
receiving, from the user, an acceptance of the additional considerations associated with the intentions;
generating a form using the identifiable information associated with the user, the answers to the questionnaire, and the intentions in the common textual format; and
transmitting the form to the one or more user-selected beneficiaries.
